(19) United States
(12) Patent Application Publication
(10) Pub. No.: US 2024/0083924 A1
(43) Pub. Date: Mar. 14, 2024

(54) PROCESS FOR PREPARING SILOXANES FROM HYDRIDOSILICON COMPOUNDS

(71) Applicant: Wacker Chemie AG, Munich (DE)

(72) Inventors: Elke Fritz-Langhals, Ottobrunn (DE); Sotirios Kneissl, Munich (DE); Phillip Piroutek, Munich (DE)

(73) Assignee: Wacker Chemie AG, Munich (DE)

(21) Appl. No.: 17/766,853

(22) PCT Filed: Oct. 11, 2019
(86) PCT No.: PCT/EP2019/077613

§ 371 Date: Apr. 6, 2022

(51) Int. Cl. C07F 7/08; C08G 77/04; C08G 77/08; C08G 77/12

(52) U.S. Cl. CPC C07F 7/0874; C08G 77/045; C08G 77/08; C08G 77/12

(57) ABSTRACT

A process for preparing siloxanes wherein (a) at least one hydridosilicon compound selected from (a1) compounds of general formula (I), and/or from (a2) compounds of general formula (I′), and (b) at least one carbonyl compound selected from (b1) compounds of the general formula (II), and/or (b2) compounds of general formula (II′), and (c) at least one cationic compound of general formula (III) are brought into contact and reacted with one another.

The invention relates to a novel process for preparing siloxanes from hydridosilicon compounds and carbonyl compounds in the presence of cationic silicon(II), germanium(II) and/or tin(II) compounds.

The production of siloxanes is an important process in industrial organosilicon chemistry. The hydrolytic condensation of chlorosilanes has been established on a large scale for this purpose, but the necessary complete removal and recycling of the hydrogen chloride formed requires considerable technical effort. Traces of acid can reduce the stability of the products and must therefore be removed. This risk does not exist under neutral and aprotic reaction conditions.

A process that meets these conditions is the Piers-Rubinsztajn reaction, in which hydridosilicon compounds are reacted with alkoxysilanes to form the corresponding siloxane and hydrocarbon in the presence of B(C₆F₅)₃ as catalyst in accordance with the equation

Si—H+Si-OR→Si—O—Si+R—H

Hydridosilicon compounds (Si—H) form a favorable raw material base that is available on an industrial scale in a wide variety of structures. In the case of alkoxysilanes (Si—OR), however, only those having the alkyl radicals methyl or ethyl are technically available, which means that highly flammable gases such as ethane or methane are formed in the Piers-Rubinsztajn reaction. This circumstance places increased demands on process reliability, renders the process considerably more expensive and can ultimately make the process uneconomical. There is therefore a need for a process for preparing siloxanes starting from hydridosilicon compounds which does not have these disadvantages. Marks et al. (Catal. Sci. Technol. 2017, 7, 2165) describe the formation of ethers from various carbonyl compounds and dimethylphenylsilane in the presence of a supported dioxomolybdenum catalyst. During this reaction, PhMe₂Si—O—SiMe₂Ph is formed as a by-product, and small amounts of alcohol are also formed. The reaction of other hydridosilicon compounds is not shown. Ketones react much more slowly than aldehydes, the reaction temperature being 100° C.

Hudnall et al. (Dalton Trans. 2016, 45, 11150) describe the formation of ethers from aldehydes and triethylsilane in the presence of 3-5 mol % of a cationic antimony(V) compound, a molar ratio of aldehyde to triethylsilane of 1:3 and a reaction temperature of 70° C. The hydrosilylation product was originally expected in the reaction. However, the ether is formed with high selectivity, and hexaethyldisiloxane is only obtained in small amounts as by-product. The reaction of ketones is not described. A disadvantage is the high proportion of catalyst, which makes the process uneconomical.

It has now been found in the context of the present invention that siloxanes are formed from hydridosilicon compounds and carbonyl compounds in the presence of cationic silicon(II), germanium(II) and/or tin(II) compounds in a selective and rapid reaction. The advantage of this process is that a large variety of carbonyl compounds is available in a technically cost-effective way and in a large structural diversity. In general, no gaseous products are formed during the reaction, which simplifies the process considerably. In addition, the siloxane is obtained in very good yields.

The invention relates to a process for preparing siloxanes, wherein
(a) at least one hydridosilicon compound selected from
(a1) compounds of general formula (I)

R¹R²R³Si—H (I),
in which the radicals R¹, R² and R³ are each independently selected from the group consisting of (i) hydrogen, (ii) halogen, (iii) unsubstituted or substituted C₁-C₂₀-hydrocarbon radical, and (iv) unsubstituted or substituted C₁-C₂₀-hydrocarbonoxy radical, wherein two of the radicals R¹, R² and R³ may also form with each other a monocyclic or polycyclic, unsubstituted or substituted C₂-C₂₀-hydrocarbon radical, wherein substituted means in each case that the hydrocarbon or hydrocarbonoxy radical each independently has at least one of the following substitutions: a hydrogen atom may be replaced by halogen, —CH(═O), —C≡N, —OR^{z}, —SR^{z}, —NR^{z}₂, and —PR^{z}₂, a CH₂ group may be replaced by —O—, —S— or —NR^{z}—, a CH₂ group not directly bonded to Si may be replaced by a —C(═O)— moiety, a CH₃ group may be replaced by a —CH(═O) moiety, and a carbon atom may be replaced by a Si atom, wherein R^{z} is each independently selected from the group consisting of C₁-C₆-alkyl radical and C₆-C₁₄-aryl radical; and/or
(a2) compounds of general formula (I′)

(SiO_{4/2})ₐ(R^{x}SiO_{3/2})_{b}(HSiO_{3/2})_{b′}(R^{x}₂SiO_{2/2})_{c}(R^{x}HSiO_{2/2})_{c′}(H₂SiO_{2/2})_{c″}(R^{x}₃SiO_{1/2})_{d}(HR^{x}₂SiO_{1/2})_{d′}(H₂R^{x}SiO_{1/2})_{d″}(H₃SiO_{1/2})_{d′″} (I′),
in which the radicals R^{x} are each independently selected from the group consisting of (i) halogen, (ii) unsubstituted or substituted C₁-C₂₀-hydrocarbon radical, and (iii) unsubstituted or substituted C₁-C₂₀-hydrocarbonoxy radical, wherein substituted means in each case that the hydrocarbon or hydrocarbonoxy radical each independently has at least one of the following substitutions: a hydrogen atom may be replaced by halogen or —CH(═O), a CH₂ group may be replaced by —O— or —NR^{z}—, where R^{z} is in each case independently selected from the group consisting of C₁-C₆-alkyl radical and C₆-C₁₄-aryl radical, a CH₂ group not directly bonded to Si may be replaced by a —O(═O)— moiety, and a CH₃ group may be replaced by a —CH(═O) moiety;
and wherein the indices a, b, b′, c, c′, c″, d, d′, d″, d′″ indicate the number of the respective siloxane unit in the compound and is each independently an integer in the range of 0 to 100 000, with the proviso that the sum of a, b, b′, c, c′, c″, d, d′, d″, d′″ together has at least the value 2 and at least one of the indices b′, c′, c″, d′, d″ or d′″ is not equal to 0; and
(b) at least one carbonyl compound selected from
(b1) compounds of general formula (II)

R^{y}—C(═O)—R^{z} (II),
wherein R^{y} is selected from the group consisting of (i) hydrogen, (ii) unsubstituted or substituted C₁-C₂₀-hydrocarbon radical, and (iii) unsubstituted or substituted C₁-C₂₀-hydrocarbonoxy radical;
and where R^{z} is selected from the group consisting of (i) hydrogen and (ii) unsubstituted or substituted C₁-C₂₀-hydrocarbon radical; and/or
(b2) compounds of general formula (II′)

(SiO_{4/2})ₐ(R^{x}SiO_{3/2})_{b}(R^{a}SiO_{3/2})_{b′}(R^{x}₂SiO_{2/2})_{c}(R^{x}R^{a}SiO_{2/2})_{c′}(R^{a}₂SiO_{2/2})_{c′}(R^{x}₃SiO_{1/2})_{d}(R^{a}R^{x}₂SiO_{1/2})_{d′}(R^{a}₂R^{x}SiO_{1/2})_{d″}(R^{a}₃SiO_{1/2})_{d′″} (II′),
where the radicals R^{a} are each independently a substituted C₂-C₂₀-hydrocarbon radical, wherein substituted means that the hydrocarbon radical each independently has at least one of the following substitutions: a CH₂ group not directly bonded to Si may be replaced by a —C(═O)— or —O—C(═O)— moiety, a hydrogen atom may be replaced by a —CH(═O) moiety, and a CH₃ group may be replaced by a —CH(═O) moiety, the hydrocarbon radical may optionally have the following further substitutions: a hydrogen atom may be replaced by halogen, a CH₂ group may be replaced by —O— or —NR^{z}—, where R^{z} is in each case independently selected from the group consisting of C₁-C₆-alkyl radical and C₆-C₁₄-aryl radical;
and wherein the radicals R^{x} are each independently selected from the group consisting of (i) halogen, (ii) hydrogen, (iii) unsubstituted or substituted C₁-C₂₀-hydrocarbon radical, and (iv) unsubstituted or substituted C₁-C₂₀-hydrocarbonoxy radical, where substituted means in each case that the hydrocarbon or hydrocarbonoxy radical each independently has at least one of the following substitutions: a hydrogen atom may be replaced by halogen, a CH₂ group may be replaced by —O— or —NR^{z}—, where R^{z} is in each case independently selected from the group consisting of C₁-C₆-alkyl radical and C₆-C₁₄-aryl radical;
and wherein the indices a, b, b′, c, c′, c″, d, d′, d″, d′″ indicate the number of the respective siloxane unit in the compound and is each independently an integer in the range of 0 to 100 000, with the proviso that the sum of a, b, b′, c, c′, c″, d, d′, d″, d′″ together has at least the value 2 and at least one of the indices b′, c′, c″, d′, d″ or d′″ is not equal to 0; and
(c) at least one cationic compound of general formula (III)

([M(II)Cp]⁺)ₐX^{a-} (III),
where M is selected from the group consisting of silicon, germanium and tin, and Cp is a π-bonded cyclopentadienyl radical of general formula (IIIa)

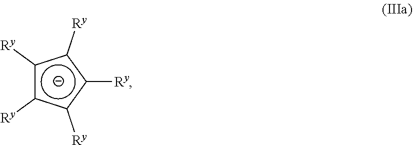

where the radicals R^{y} are each independently selected from the group consisting of (i) triorganosilyl radical of formula —SiR^{b}₃, where the radicals Rb are each independently C₁-C₂₀-hydrocarbon radical, (ii) hydrogen, (iii) unsubstituted or substituted C₁-C₂₀-hydrocarbon radical, and (iv) unsubstituted or substituted C₁-C₂₀-hydrocarbonoxy radical, wherein two radicals R^{y} may in each case also form with each other a monocyclic or polycyclic C₂-C₂₀-hydrocarbon radical, and where substituted means in each case that in the hydrocarbon or hydrocarbonoxy radical at least one carbon atom may also be replaced by one Si atom,
X^{a-} is an a valent anion and
a can take the values 1, 2 or 3;
are brought into contact and reacted.

In the process according to the invention, ethers are also obtained as further reaction products.

At least one hydridosilicon compound is used, which also means that mixtures of compounds of general formula (I) and/or mixtures of compounds of general formula (I′) are included.

In the general formula (I), the radicals R¹, R² and R³ are preferably each independently selected from the group consisting of (i) hydrogen, (ii) chlorine, (iii) unsubstituted or substituted C₁-C₁₂-hydrocarbon radical, and (iv) unsubstituted or substituted C₁-C₁₂-hydrocarbonoxy radical, where substituted has the same definition as before; and in the general formula (I′), the radicals R^{x} are preferably each independently selected from the group consisting of (i) chlorine, (ii) C₁-C₆-alkyl radical, (iii) phenyl, and (iv) C₁-C₆-alkoxy radical, and the indices a, b, b′, c, c′, c″, d, d′, d″, d′″ are each independently selected from an integer in the range of 0 to 1000.

In the general formula (I), the radicals R¹, R² and R³ are particularly preferably each independently selected from the group consisting of (i) hydrogen, (ii) chlorine, (iii) 01-C₆-alkyl radical, (iv) phenyl, and (v) C₁-C₆-alkoxy radical; and in the general formula (I′), the radicals R^{x} are particularly preferably each independently selected from the group consisting of chlorine, methyl, methoxy, ethyl, ethoxy, n-propyl, n-propoxy and phenyl, and the indices a, b, b′, c, c′, c″, d, d′, d″, d′″ are each independently selected from an integer in the range of 0 to 1000.

In the general formula (I) the radicals R¹, R² and R³ and in the general formula (I′) the radicals R^{x} are especially preferably each independently selected from the group consisting of hydrogen, chlorine, methyl, methoxy, ethyl, ethoxy, n-propyl, n-propoxy and phenyl, and the indices a, b, b′, c, c′, c″, d, d′, d″, d′″ are preferably each independently selected from an integer in the range of 0 to 1000.

A mixture of compounds of formula (I′) is particularly present in polysiloxanes. For the sake of simplicity, however, the individual compounds of the mixture are not given for polysiloxanes, but an average formula (I′a) similar to formula (I′) is given:

(SiO_{4/2})ₐ(R^{x}SiO_{3/2})_{b}(HSiO_{3/2})_{b′}(R^{x}₂SiO_{2/2})_{c}(R^{x}₂SiO_{2/2})_{c}(R^{x}HSiO_{2/2})_{c′}(H₂SiO_{2/2})_{c′}(H₂SiO_{2/2})_{d″}(R^{x}₃SiO_{1/2})_{d}(HR^{x}₂SiO_{1/2})_{d′}(H₂R^{x}SiO_{1/2})_{d″}(H₃SiO_{1/2})_{d′″} (I′a),
where the radicals R^{x} have the same definition as in formula (I′), the indices a, b, b′, c, c′, c″, d, d′, d″, d′″, however, are each independently a number in the range of 0 to 100 000 and indicate the average content of the respective siloxane unit in the mixture. Preferably, such mixtures of the average formula (I′a) are selected in which the indices a, b, b′, c, c′, c″, d, d′, d″, d′″ are each independently selected from a number in the range of 0 to 20 000.

Examples of hydridosilicon compounds of general formula (I) are the following silanes (Ph=phenyl, Me=methyl, Et=ethyl):
Me₃SiH, Et₃SiH, Me₂PhSiH, MePh₂SiH, PhCl₂SiH, Me₂ClSiH, Et₂ClSiH, Mecl₂SiH, Cl₃SiH, Cl₂SiH₂, Me₂(MeO)SiH, Me(MeO)₂SiH, (MeO)₃SiH, Me₂(EtO)SiH, Me(EtO)₂SiH, (EtO)₃SiH,
Me₂SiH₂, Et₂SiH₂, MePhSiH₂, Ph₂SiH₂, PhClSiH₂, MeClSiH₂, EtClSiH₂, Cl₂SiH₂,
Me(MeO)SiH₂, (MeO)₂SiH₂, Me₂(EtO)SiH, (EtO)₂SiH₂ and PhSiH₃ and 1,4-bis(dimethylsilyl)benzene.

Examples of hydridosilicon compounds of general formula (I′) are the following siloxanes and polysiloxanes:
HSiMe₂—O—SiMe₃, HSiMe₂—O—SiMe₂H, Me₃Si—O—SiHMe-O—SiMe₃,
H—SiMe₂-(0-SiMe₂)ₘ—O—SiMe₂—H where m=1 to 20 000,
Me₃Si—O—(SiMe₂—O)ₙ(SiHMe-O)ₒ—SiMe₃ where n=1 to 20 000 and o=1 to 20 000.

At least one carbonyl compound is used, which also includes mixtures of compounds of general formula (II) and/or mixtures of compounds of general formula (II′).

In formula (II) the radicals R^{y} are preferably selected from the group consisting of (i) hydrogen, (ii) unsubstituted C₁-C₈-hydrocarbon radical and (iii) unsubstituted hydrocarbonoxy radical, and the radicals R^{z} are selected from the group consisting of (i) hydrogen and (ii) unsubstituted C₁-C₈-hydrocarbon radical; and in formula (II′) the radicals R^{a} are preferably selected from the group consisting of substituted C₁-C₈-hydrocarbon radicals and the substituents are the same as before, and the radicals R^{x} are selected from (i) unsubstituted C₁-C₈-hydrocarbon radical and (ii) unsubstituted C₁-C₈-hydrocarbonoxy radical.

In formula (II) the radicals R^{y} are particularly preferably selected from the group consisting of (i) hydrogen, (ii) C₁-C₈-alkyl radical and (iii) C₁-C₈-alkoxy radical, and the radicals R^{z} are selected from the group consisting of (i) hydrogen, (ii) C₁-C₈-alkyl radical and (iii) phenyl radical; and in formula (II′) the radicals R^{a} are particularly preferably selected from the group consisting of substituted C₁-C₈-hydrocarbon radicals and the substituents are the same as before, and the radicals R^{x} are selected from unsubstituted C₁-C₈-hydrocarbon radicals.

At least one cationic compound is used, mixtures of compounds of general formula (111) also being included.

In formula (111), M is selected from the group consisting of silicon, germanium and tin, with preference being given to silicon and germanium, and particular preference being given to silicon.

Examples of radicals R^{y} in formula (IIIa) are alkyl radicals such as the methyl, ethyl, n-propyl, isopropyl, n-butyl, sec-butyl, isobutyl, tert-butyl, n-pentyl, sec-pentyl, isopentyl, neopentyl and tert-pentyl radical; hexyl radicals such as the n-hexyl radical; heptyl radicals such as the n-heptyl radical; octyl radicals such as the n-octyl radical, and isooctyl radicals such as the 2,4,4-trimethylpentyl radical; nonyl radicals such as the n-nonyl radical; decyl radicals such as the n-decyl radical; dodecyl radicals such as the n-dodecyl radical; hexadecyl radicals such as the n-hexadecyl radical; octadecyl radicals such as the n-octadecyl radical; cycloalkyl radicals such as the cyclopentyl, cyclohexyl and cycloheptyl radical, and the methylcyclohexyl radical; aryl radicals such as the phenyl, naphthyl, anthracene and phenanthrene radical; alkaryl radicals such as the o-, m- and p-tolyl, xylyl, mesitylenyl and o-, m- and p-ethylphenyl radical; alkaryl radicals such as the benzyl radical, the α- and the β-phenylethyl radical; and alkylsilyl radicals such as the trimethylsilyl, triethylsilyl, tripropylsilyl, dimethylethylsilyl, dimethyl-tert-butylsilyl and diethylmethylsilyl radical.

In formula (IIIa) the radicals R^{y} are preferably each independently selected from the group consisting of (i) C₁-C₃-alkyl radical, (ii) hydrogen and (iii) triorganosilyl radical of formula —SiR^{b}₃, where the radicals Rb are each independently C₁-C₂₀-alkyl radicals. The radicals R^{y} are particularly preferably each independently selected from methyl radical, hydrogen and trimethylsilyl radical. All radicals R^{y} are especially preferably a methyl radical.

The index a in formula (111) is preferably 1, so that X⁻ is a monovalent anion.

Examples of anions X⁻ are:
halides;
chlorate ClO₄⁻,
tetrachlorometallates [MCl₄]⁻ where M=Al, Ga;
tetrafluoroborates [BF₄]⁻;
trichlorometallates [MCl₃]⁻ where M=Sn, Ge;
hexafluorometallates [MF₆]⁻ where M=As, Sb, Ir, Pt;
perfluoroantimonates [Sb₂F₁₁]⁻, [Sb₃F₁₆]⁻ and [Sb₄F₂₁]⁻;
triflate (=trifluoromethanesulfonate) [OSO₂CF₃]⁻;
tetrakis(trifluoromethyl)borate [B(CF₃)₄]⁻; tetrakis(pentafluorophenyl)metallates [M(C₆F₅)₄]⁻ where M=Al, Ga;
tetrakis(pentachlorophenyl)borate [B(C₆Cl₅)₄]⁻;
tetrakis[(2,4,6-trifluoromethyl(phenyl))]borate {B[C₆H₂(CF₃)₃]}₋;
hydroxybis[tris(pentafluorophenyl)borate]{HO[B(C₆F₅)₃]₂}⁻;
closo-carborates [CHB₁₁H₅Cl₆]⁻, [CHB₁₁H₅Br₆]⁻, [CHB₁₁(CH₃)₅Br₆]⁻, [CHB₁₁F₁₁]⁻, [C(Et)B₁₁F₁₁]⁻, [CB₁₁(CF₃)₁₂]⁻ and [B₁₂Cl₁₁N(CH₃)₃]⁻,
tetra(perfluoroalkoxy)aluminates [Al(OR^{PF})₄]⁻ where R^{PF}=each independently perfluorinated C₁-C₁₄-hydrocarbon radical;
tris(perfluoroalkoxy)fluoroaluminates [FAI(OR^{PF})₃]⁻ where R^{PF}=each independently perfluorinated C₁-C₁₄-hydrocarbon radical;
hexakis(oxypentafluorotellurium)antimonate [Sb(OTeF₅)₆]⁻;
borates and aluminates of the formulae [B(R^{a})₄]⁻ and [Al(R^{a})₄]⁻, where the radicals R^{a} are each independently selected from aromatic C₆-C₁₄-hydrocarbon radical, in which at least one hydrogen atom has been independently substituted by a radical selected from the group consisting of (i) fluorine, (ii) perfluorinated C₁-C₆-alkyl radical, and (iii) triorganosilyl radical of formula —SiR^{b}₃, where the radicals Rb are each independently C₁-C₂₀-alkyl radicals.

In formula (III), the anions X⁻ are preferably selected from the group consisting of the compounds of the formulae [B(R^{a})₄]⁻ and [Al(R^{a})₄]⁻, where the radicals R^{a} are each independently selected from aromatic C₆-C₁₄-hydrocarbon radicals in which at least one hydrogen atom has been each independently substituted by a radical selected from the group consisting of (i) fluorine, (ii) perfluorinated C₁-C₆-alkyl radical, and (iii) triorganosilyl radical of the formula —SiR^{b}₃, where the radicals Rb are each independently C₁-C₂₀-alkyl radical.

Examples of radicals R^{a} are m-difluorophenyl radical, 2,2,4,4-tetrafluorophenyl radical, perfluorinated 1-naphthyl radical, perfluorinated 2-naphthyl radical, perfluorobiphenyl radical, —C₆F₅, —C₆H₃(m-CF₃)₂, —C₆H₄(p-CF₃), —C₆H₂(2,4,6-CF₃)₃, —C₆F₃(m-SiMe₃)₂, —C₆F₄(p-SiMe₃), —C₆F₄(p-SiMe₂t-butyl).

In formula (III), the anions X⁻ are particularly preferably selected from the group consisting of the compounds of formula [B(R^{a})₄]⁻, where the radicals R^{a} are each independently selected from aromatic C₆-C₁₄-hydrocarbon radicals in which all hydrogen atoms have been each independently substituted by a radical selected from the group consisting of (i) fluorine and (ii) triorganosilyl radical of the formula —SiR^{b}₃, where the radicals Rb are each independently C₁-C₂₀-alkyl radicals.

In formula (III), the anions X⁻ are especially preferably selected from the group consisting of the compounds of the formula [B(R^{a})₄]⁻, where the radicals R^{a} are each independently selected from the group consisting of —C₆F₅, perfluorinated 1- and 2-naphthyl radicals, —C₆F₃(SiR^{b}₃)₂ and —C₆F₄(SiR^{b}₃), where the radicals Rb are each independently C₁-C₂₀-alkyl radicals.

In formula (III), the anions X⁻ are most preferably selected from the group consisting of [B(C₆F₅)₄]⁻, [B(C₆F₄)(4-TBS)₄]⁻ where TBS=SiMe₂tert-butyl, [B(2-NaphF)₄]⁻ where 2-NaphF=perfluorinated 2-naphthyl radical and [B(C₆F₅)₃(2-NaphF)]⁻ where 2-NaphF=perfluorinated 2-naphthyl radical.

Preferred compounds of the formula (III) are those in which all radicals R^{y} are methyl and the anions X⁻ are selected from the group consisting of the compounds of the formula [B(R^{a})₄]⁻, where the radicals R^{a} are each independently selected from aromatic C₆-C₁₄-hydrocarbon radicals in which at least one hydrogen atom has been each independently substituted by a radical selected from the group consisting of (i) fluorine, (ii) perfluorinated C₁-C₆-alkyl radical, and (iii) triorganosilyl radical of the formula —SiR^{b}₃, where the radicals Rb are each independently C₁-C₂₀-alkyl radicals.

Cationic compounds of the formula (III) are particularly preferably selected from the group consisting of Cp*M+B(C₆F₅)₄⁻;
Cp*M⁺B[C₆F₄(4-TBS)]₄⁻, where TBS=SiMe₂tert-butyl,
Cp*M⁺B(2-NaphF)₄⁻, where 2-NaphF=perfluorinated 2-naphthyl radical; and
Cp*M^{+B[(C}₆F₅)₃(2-NaphF)]⁻, where 2-NaphF=perfluorinated 2-naphthyl radical,
where M is selected from the group consisting of silicon and germanium and Cp* is pentamethylcyclopentadienyl.

In a particular embodiment of the process according to the invention, the compound of the formula (I) has two silicon-bonded hydrogen atoms, where the radicals R¹ and R² have the same definition as before: R¹R²SiH₂.

In this case, linear polysiloxanes can be produced in the reaction with carbonyl compounds (cf. reaction scheme 1, applies to aldehydes and ketones). This also applies when compounds of the formula (I′) having two terminal Si—H moieties are used.

(n+2)R¹R²SiH₂+(n+1)R^{y}R^{z}C═O→HR¹R²Si—(O—SiR¹R²)ₙ—O—SiR¹R²H+(n+1)R^{y}R^{z}CH—O—CHR^{y}R^{z} (reaction scheme 1)

In a further particular embodiment of the process according to the invention, copolymers are obtained when two or more different compounds of the formula (I) are used each having two silicon-bonded hydrogen atoms. This also applies if two or more different compounds of the formula (I′) having two terminal Si—H moieties are used.

If the compound of the formula (I) or (I′) comprises at least three silicon-bonded hydrogens, branched or crosslinked siloxanes are formed.

In another embodiment, the compound of formula (I′) comprises two or more Si—H moieties and two or more carbonyl moieties. Crosslinked siloxanes are then likewise obtained in the reaction.

The reactants and catalyst may be brought into contact with one another in any sequence. Preferably, contacting means that the reactants and the catalyst are mixed, the mixing being carried out in a manner known to those skilled in the art. For example, the compounds of formula (I) or (I′) and (II) or (II′) can be mixed with each other and then the compound of formula (III) can be added. It is also possible to first mix the compounds of the formula (I) or (I′) or (II) or (II′) with the compound of formula (III), and then to add the missing compound.

The molar ratio between the hydrogen atoms directly bonded to silicon and carbonyl moieties present is usually in the range from 1:100 to 100:1, the molar ratio preferably being in the range from 1:10 to 10:1, particularly preferably in the range from 1:2 to 2:1

The molar proportion of the compound of formula (III), based on the Si—H moieties present of the compound of formula (I) or (I′), is preferably in the range from 0.0001 mol % to 10 mol %, particularly preferably in the range from 0.001 mol % to 1 mol %, especially preferably in the range from 0.01 mol % to 0.1 mol %.

The reaction according to the invention may be carried out without solvent or with the addition of one or more solvents. The proportion of the solvent or the solvent mixture, based on the compound of the formula (I) or (I′), is preferably at least 0.01% by weight and at most 1000-fold the amount by weight, particularly preferably at least 1% by weight and at most 100-fold the amount by weight, especially preferably at least 10% by weight and at most 10-fold the amount by weight. The compound of the formula (III) is preferably dissolved in a solvent prior to the reaction.

The solvents that may be used are preferably aprotic solvents, for example hydrocarbons such as pentane, hexane, heptane, cyclohexane or toluene, chlorohydrocarbons such as dichloromethane, chloroform, chlorobenzene or 1,2-dichloroethane, ethers such as diethyl ether, methyl tert-butyl ether, anisole, tetrahydrofuran or dioxane, or nitriles such as acetonitrile or propionitrile.

Preference is given to solvents or solvent mixtures having a boiling point or boiling range of up to 120° C. at 0.1 MPa.

The solvents are preferably chlorinated and non-chlorinated aromatic or aliphatic hydrocarbons.

The reaction pressure may be freely chosen by the person skilled in the art; it can be carried out under ambient pressure or under reduced or elevated pressure. The pressure is preferably in a range from 0.01 bar to 100 bar, particularly preferably in a range from 0.1 bar to 10 bar, and the reaction is especially preferably carried out at ambient pressure. However, if compounds I or II are involved in the reaction according to the invention which are gaseous at the reaction temperature, the reaction is preferably carried out at elevated pressure, particularly preferably at the vapor pressure of the entire system.

The person skilled in the art may freely choose the temperature of the reaction. The reaction is preferably carried out at a temperature in the range of −40° C. to +200° C., particularly preferably in the range of −10° C. to +150° C., especially preferably in the range of +10° C. to +120° C.

The process according to the invention can also be used, for example, to remove small proportions of Si—H moieties which are present as labile and therefore often interfering impurities in applications in products that have been prepared via other processes, by reacting them with a compound of the formula (II) or (II′) in the presence of a compound of the formula (III). The reactive Si—H moieties are converted here into inert Si—O—Si moieties.

### EXAMPLES

### Example 1: Reaction of Triethylsilane with Hexanal

Under an argon atmosphere, a solution of 1.3 mg of Cp*Si+B(C₆F₅)₄⁻ (1.5 μmol, 0.059 mol %) in 940 mg of dichloromethane was initially charged and then 30.2 mg (2.60 mmol) of triethylsilane and 259 mg (2.59 mmol) of hexanal were added. The reaction was exothermic and was complete after 0.5 h.

The yield of hexaethyldisiloxane was 99% (GC analysis) of the theoretical value.

### Example 2: Reaction of Triethylsilane with Hexanal

299 mg (2.57 mmol) of triethylsilane and 257 mg (2.57 mmol) of hexanal were mixed. To this mixture were added slowly dropwise 2.8 mg (3.2 μmol, 0.12 mol % based on hexanal) of Cp*Ge+B(C₆F₅)₄⁻ as a solution in 780 mg of dichloromethane. After one hour at 50° C. the reaction was complete.

The yield of hexaethyldisiloxane was 98% (GC analysis) of the theoretical value.

¹H-NMR (CD₂Cl₂): δ=0.54 (m, 6 CH₂), 0.95 ppm (6 CH₃)

### Example 3: Reaction of Triethylsilane with Ethyl Methyl Ketone

Under an argon atmosphere, a solution of 1.1 mg of Cp*Si+B(C₆F₅)₄⁻ (1.3 μmol, 0.05 mol % based on triethylsilane) in 853 mg of dichloromethane was initially charged, then 301 mg (2.59 mmol) of triethylsilane and 188 mg (2.60 mmol) of ethyl methyl ketone were added. The reaction was strongly exothermic and was complete after 0.5 h.

The yield of hexaethyldisiloxane was 81% (GC analysis) of the theoretical value.

### Example 4: Reaction of Triethylsilane with Ethyl Methyl Ketone

Under an argon atmosphere, a solution of 3.5 mg of Cp*Si+B(C₆F₅)₄⁻ (4.15 μmol, 0.05 mol % based on triethylsilane) in 15 g of dichloromethane was initially charged and then 1011 mg (8.70 mmol) of triethylsilane were added. To the solution, cooled to −74° C., were added 629 mg (8.72 mmol) of ethyl methyl ketone. The reaction solution was then slowly brought to room temperature. After 1.5 h at room temperature, 76% hexaethyldisiloxane was formed (GC analysis), starting from the theoretical value.

### Example 5: Reaction of Dimethylchlorosilane with Ethyl Methyl Ketone

Under argon, 0.5 mg of Cp*Ge+B(C₆F₅)₄⁻ (0.56 μmol, 0.021 mol % based on 2-butanone) was dissolved in 660 mg of dichloromethane. To this solution was added a mixture of 252 mg (2.66 mmol) of dimethylchlorosilane and 195 mg (2.70 mmol) of ethyl methyl ketone. An exothermic reaction was observed. After 24 hours at room temperature, 1,3-dichloro-1,1,3,3-tetramethyldisiloxane had formed (GC analysis), starting from the theoretical value.

### Example 6: Reaction of Pentamethyldisiloxane with Hexanal

Under an argon atmosphere, a solution of 3.2 mg of Cp*Ge+B(C₆F₆)₄⁻ (3.6 μmol, 0.05 mol % based on pentamethyldisiloxane) in 15.6 g of dichloromethane and 1.00 g (6.77 mmol) of pentamethyldisiloxane was initially charged. To the solution, cooled to +2° C., were added 676 mg (6.75 mmol) of hexanal. The reaction solution was slowly brought to room temperature and then stirred at room temperature for 18 h.

The yield of decamethyltetrasiloxane was 56% (GC analysis) of the theoretical value.

### Example 7: Reaction of Triethylsilane with Acetophenone

Under an argon atmosphere, a solution of 1.2 mg of Cp*Si+B(C₆F₅)₄⁻ (1.4 μmol, 0.055 mol % based on triethylsilane) in 860 mg of dichloromethane was initially charged and then 312 mg (2.59 mmol) of triethylsilane and 312 mg (2.60 mmol) of acetophenone were added. The reaction solution was heated to 70° C. for 15 minutes.

The yield of hexaethyldisiloxane was 98% (GC analysis) of the theoretical value.

### Example 8: Reaction of Triethylsilane with Acetophenone (1:1)

Under argon, a mixture of 301 mg (2.59 mmol) of triethylsilane, 313 mg (2.61 mg) of acetophenone and 340 mg of CD₂Cl₂ was prepared. This mixture was slowly added dropwise to a solution of 2.3 mg (2.6 μmol, 0.10 mol % based on acetophenone) of Cp*Ge+B(C₆F₅)₄⁻ in 713 mg of dichloromethane. After 24 hours at 50° C., all of the triethylsilane had reacted.

The yield of hexaethyldisiloxane was 98% (GC analysis) of the theoretical value.

### Example 9: Reaction of Triethylsilane with Acetophenone (2:1)

Under argon, a mixture of 399 mg (3.43 mmol) of triethylsilane, 210 mg (1.75 mg) of acetophenone and 370 mg of CD₂Cl₂ was prepared. This mixture was slowly added dropwise to a solution of 3.1 mg (3.5 μmol, 0.20 mol % based on acetophenone) of Cp*Ge+B(C₆F₅)₄⁻ in 380 mg of dichloromethane. After 23 hours at 50° C., the reaction was complete.

The yield of hexaethyldisiloxane was 99% (GC analysis) of the theoretical value.

### Example 10: Reaction of Triethylsilane with Ethyl Acetate

304 mg (2.61 mmol) of triethylsilane and 116 mg (1.32 mmol) of ethyl acetate were mixed. To this mixture was added a solution of 1.2 mg (1.4 μmol, 0.11 mol % based on ethyl acetate) of Cp*Ge+B(C₆F₅)₄⁻ in 346 mg of dichloromethane. The reaction mixture was heated at 70° C. for 16 hours. Triethylsilane had reacted completely.

The yield of hexaethyldisiloxane was 43% (GC analysis) of the theoretical value.

### Example 11: Reaction of Triethylsilane with Ethyl Acetate

302 mg (2.60 mmol) of triethylsilane and 117 mg (1.33 mmol) of ethyl acetate were mixed. To this mixture was added a solution of 1.1 mg (1.3 μmol, 0.098 mol %) of Cp*Si+B(C₆F₅)₄⁻ in 346 mg of dichloromethane. The reaction mixture was heated at 70° C. for 16 hours. Triethylsilane had reacted completely.

The yield of hexaethyldisiloxane was 50% (GC analysis) of the theoretical value.

### Example 12: Reaction of Triethylsilane with Ethyl Propionate

300 mg (2.58 mmol) of triethylsilane and 130 mg (1.27 mmol) of ethyl propionate were mixed. To this mixture was added a solution of 1.2 mg (1.4 μmol, 0.11 mol %) of Cp*Ge+B(C₆F₅)₄⁻ in 360 mg of dichloromethane. The reaction mixture was heated at 70° C. for 16 hours. Triethylsilane had reacted completely.

The yield of hexaethyldisiloxane was 56% (GC analysis) of the theoretical value.

### Example 13: Reaction of 1,1,3,3-Tetramethyldisiloxane with Hexanal (Synthesis of a Linear Siloxane Polymer)

1.00 g (7.46 mmol) of 1,1,3,3-tetramethyldisiloxane, 1.49 g (14.9 mmol) of hexanal and 6.5 g of dichloromethane were mixed and a solution of 1.7 mg (2.02 μmol, 0.03 mol %) of Cp*Si+B(C₆F₅)₄⁻ in 1 g of dichloromethane was added with stirring at 10° C.

The solution was warmed to 40° C. and then again returned to ambient temperature (25° C.). After a total reaction time of 2 hours, Si—H was no longer detectable by NMR spectroscopy. ²⁹Si-NMR (CD₂Cl₂): δ=−6.78 (Si—H chain end),−19.8 (HSi—O—SiMe₂O—), −21.8 (SiMe₂O chain link), calculated average chain length: 42 silicone units.

### Example 14: Reaction of 1,1,3,3-Tetramethyldisiloxane and Diethylsilane with Hexanal (Synthesis of a Linear Siloxane Copolymer)

0.50 g (3.74 mmol) of 1,1,3,3-tetramethyldisiloxane, 0.329 mg (3.73 mmol) of diethylsilane, 1.49 g (14.9 mmol) of hexanal and 6.5 g of dichloromethane were mixed and a solution of 1.6 mg (1.90 μmol, 0.025 mol %) of Cp*Si+B(C₆F₅)₄⁻ in 1.1 g of dichloromethane was added with stirring at 25° C. After a total reaction time of ca. 2 days, Si—H was no longer detectable by ¹H-NMR spectroscopy. The reaction solution was evaporated under reduced pressure. GPC measurement: Mₙ=3830, M_{w}=12 316, D=3.2.

### Example 15: Reaction of 1,1,3,3-Tetramethyldisiloxane and Diphenylsilane with Hexanal (Synthesis of a Siloxane Copolymer)

0.50 g (3.74 mmol) of 1,1,3,3-tetramethyldisiloxane, 0.687 mg (3.73 mmol) of diphenylsilane, 1.49 g (14.9 mmol) of hexanal and 4.7 g of dichloromethane were mixed and a solution of 1.4 mg (1.90 μmol, 0.022 mol %) of Cp*Si+B(C₆F₅)₄⁻ in 1.1 g of dichloromethane was added with stirring at 20° C. The solution was heated to a bath temperature of 60° C. for 22 hours, after which time the reaction was complete (no Si—H signals detectable in the ¹H-NMR spectrum). The reaction solution was evaporated under reduced pressure. GPC measurement: Mₙ=3375, M_{w}=7755, D=2.3.

### Example 16: Reaction of 1,1,3,3-Tetramethyldisiloxane and 1,4-Bis(Dimethylsilyl)Benzene with Hexanal (Synthesis of a Siloxane Copolymer)

0.52 g (3.74 mmol) of 1,1,3,3-tetramethyldisiloxane, 0.728 mg (3.74 mmol) of 1,4-bis(dimethylsilyl)benzene, 1.49 g (14.9 mmol) of hexanal and 3.1 g of dichloromethane were mixed and a solution of 1.5 mg (1.78 μmol, 0.024 mol %) of Cp*Si+B(C₆F₅)₄⁻ in 1.1 g of dichloromethane was added with stirring at 25° C. The solution was warmed to 40° C. and then again returned to ambient temperature (25° C.).

After a total reaction time of 22 hours, the reaction was complete (no Si—H signals detectable in the ¹H-NMR spectrum). The reaction solution was evaporated under reduced pressure. GPC measurement: Mₙ=2581, M_{w}=7819, D=3.0.

### Example 17: Reaction of 1,1,3,3-Tetramethyldisiloxane and Diphenylsilane with Hexanal (Synthesis of a Siloxane Copolymer)

0.50 g (3.74 mmol) of 1,1,3,3-tetramethyldisiloxane, 0.687 mg (3.73 mmol) of diphenylsilane, 1.49 g (14.9 mmol) of hexanal and 4.7 g of dichloromethane were mixed and a solution of 1.4 mg (1.90 μmol, 0.022 mol %) of Cp*Si+B(C₆F₅)₄⁻ in 1.1 g of dichloromethane was added with stirring at 20° C. The solution was heated to a bath temperature of 60° C. for 22 hours, after which time the reaction was complete (no Si—H signals detectable in the ¹H-NMR spectrum). The reaction solution was evaporated under reduced pressure. GPC measurement: Mₙ=3375, M_{w}=7755, D=2.3.

### Example 18: Reaction of 1,1,3,3-Tetramethyldisiloxane and 1,4-Bis(Dimethylsilyl)Benzene with Hexanal (Synthesis of a Siloxane Copolymer)

0.52 g (3.74 mmol) of 1,1,3,3-tetramethyldisiloxane, 0.728 mg (3.74 mmol) of 1,4-bis(dimethylsilyl)benzene, 1.49 g (14.9 mmol) of hexanal and 3.1 g of dichloromethane were mixed and a solution of 1.5 mg (1.78 μmol, 0.024 mol %) of Cp*Si+B(C₆F₅)₄⁻ in 1.1 g of dichloromethane was added with stirring at 25° C. The solution was warmed to 40° C. and then again returned to ambient temperature (25° C.). After a total reaction time of 22 hours, the reaction was complete (no Si—H signals detectable in the ¹H-NMR spectrum). The reaction solution was evaporated under reduced pressure. GPC measurement: Mₙ=2581, M_{w}=7819, D=3.0.

### Example 19: Reaction of 1,4-Bis(Dimethylsilyl)Benzene with Hexanal (Synthesis of a Copolymer)

A solution of 3.50 g (18.0 mmol) of 1,4-bis(dimethylsilyl)benzene and 3.62 mg (36.1 mmol) of hexanal was initially charged under an argon atmosphere in 4.5 g of dichloromethane. To this mixture were slowly added dropwise 3.3 mg (3.9 μmol, 0.02 mol % based on 1,4-bis(dimethylsilyl)benzene) of Cp*Si+B(C₆F₅)₄⁻ as a solution in 1.1 g of dichloromethane. After 2 hours at 50° C., 1,4-bis(dimethylsilyl)benzene was almost completely consumed. The polymer H—SiMe₂-[(1,4-phenyl)-SiMe₂—O—SiMe₂—]ₙ(1,4-phenyl)-SiMe₂H was formed. The chain length was determined by determining the Si—H end groups in the ¹H-NMR spectrum at δ=4.44 ppm, n=220.

NMR data of the polymer formed:

¹H-NMR (CD₂Cl₂): δ=0.37 (s, SiMe₂), 7.58 (s, phenyl);

²⁹Si-NMR (CD₂Cl₂): δ=−1.12 ppm (Si—O-phenyl chain link).

1-10. (canceled)

11. A process for preparing siloxanes, wherein
(a) at least one hydridosilicon compound selected from
(a1) compounds of general formula (I)
R¹R²R³Si—H (I),
in which the radicals R¹, R² and R³ are each independently selected from the group consisting of (i) hydrogen, (ii) halogen, (iii) unsubstituted or substituted C₁-C₂₀-hydrocarbon radical, and (iv) unsubstituted or substituted C₁-C₂₀-hydrocarbonoxy radical, wherein two of the radicals R¹, R² and R³ may also form with each other a monocyclic or polycyclic, unsubstituted or substituted C₂-C₂₀-hydrocarbon radical, wherein substituted means in each case that the hydrocarbon or hydrocarbonoxy radical each independently has at least one of the following substitutions: a hydrogen atom may be replaced by halogen, —CH(═O), —OR^{z}, —SR^{z}, —NR^{z}₂, and —PR^{z}₂, a CH₂ group may be replaced by —O—, —S— or —NR′—, a CH₂ group not directly bonded to Si may be replaced by a —C(═O)— moiety, a CH₃ group may be replaced by a —CH(═O) moiety, and a carbon atom may be replaced by a Si atom, wherein R′ is each independently selected from the group consisting of C₁-C₆-alkyl radical and C₆-C₁₄-aryl radical; and/or
(a2) compounds of general formula (I′)
(SiO_{4/2})ₐ(R^{x}SiO_{3/2})_{b}(HSiO_{3/2})_{b′}(R^{x}₂SiO_{2/2})_{c}(R^{x}HSiO_{2/2})_{c′}(H₂SiO_{2/2})_{c″}(R^{x}₃SiO_{1/2})_{d}(HR^{x}₂SiO_{1/2})_{d′}(H₂R^{x}SiO_{1/2})_{d″}(H₃SiO_{1/2})_{d′″} (I′),
in which the radicals R^{x} are each independently selected from the group consisting of (i) halogen, (ii) unsubstituted or substituted C₁-C₂₀-hydrocarbon radical, and (iii) unsubstituted or substituted C₁-C₂₀-hydrocarbonoxy radical, wherein substituted means in each case that the hydrocarbon or hydrocarbonoxy radical each independently has at least one of the following substitutions: a hydrogen atom may be replaced by halogen or —CH(═O), a CH₂ group may be replaced by —O— or —NR^{z}—, where W is in each case independently selected from the group consisting of C₁-C₆-alkyl radical and C₆-C₁₄-aryl radical, a CH₂ group not directly bonded to Si may be replaced by a —C(═O)— moiety, and a CH₃ group may be replaced by a —CH(═O) moiety;
and wherein the indices a, b, b′, c, c′, c″, d, d′, d″, d′″ indicate the number of the respective siloxane unit in the compound and is each independently an integer in the range of 0 to 100 000, with the proviso that the sum of a, b, b′, c, c′, c″, d, d′, d″, d′″ together has at least the value 2 and at least one of the indices b′, c′, c″, d′, d″ or d′″ is not equal to 0; and
(b) at least one carbonyl compound selected from
(b1) compounds of general formula (II)
R^{y}—C(═O)—R^{z} (II),
wherein R^{y} is selected from the group consisting of (i) hydrogen, (ii) unsubstituted or substituted C₁-C₂₀-hydrocarbon radical, and (iii) unsubstituted or substituted C₁-C₂₀-hydrocarbonoxy radical;
and where R^{z} is selected from the group consisting of (i) hydrogen and (ii) unsubstituted or substituted C₁-C₂₀-hydrocarbon radical; and/or
(b2) compounds of general formula (II′)
(SiO_{4/2})ₐ(R^{x}SiO_{3/2})_{b}(R^{a}SiO_{3/2})_{b}(R^{a}SiO_{3/2})_{b′}(R^{x}₂SiO_{2/2})_{c}(R^{x}R^{a}SiO_{2/2})_{c′}(R^{a}₂SiO_{2/2})_{c″}(R^{x}₃SiO_{1/2})_{d}(R^{a}R^{x}₂Si O_{1/2})_{d′}(R^{a}₂R^{x}SiO_{1/2})_{d″}(R^{a}₃SiO_{1/2})_{d′″} (II′),
where the radicals R^{a} are each independently a substituted C₂-C₂₀-hydrocarbon radical,
wherein substituted means that the hydrocarbon radical each independently has at least one of the following substitutions: a CH₂ group not directly bonded to Si may be replaced by a —C(═O)— or —OC(═O)— moiety, a hydrogen atom may be replaced by a —CH(═O) moiety, and a CH₃ group may be replaced by a —CH(═O) moiety, the hydrocarbon radical may optionally have the following further substitutions: a hydrogen atom may be replaced by halogen, a CH₂ group may be replaced by —O— or —NR^{z}—, where R^{z} is in each case independently selected from the group consisting of C₁-C₆-alkyl radical and C₆-C₁₄-aryl radical;
and wherein the radicals R^{x} are each independently selected from the group consisting of (i) halogen, (ii) hydrogen, (iii) unsubstituted or substituted C₁-C₂₀-hydrocarbon radical, and (iv) unsubstituted or substituted C₁-C₂₀-hydrocarbonoxy radical, where substituted means in each case that the hydrocarbon or hydrocarbonoxy radical each independently has at least one of the following substitutions: a hydrogen atom can be replaced by halogen, a CH₂ group may be replaced by —O— or —NR^{z}—, where R^{z} is in each case independently selected from the group consisting of C₁-C₆-alkyl radical and C₆-C₁₄-aryl radical;
and wherein the indices a, b, b′, c, c′, c″, d, d′, d″, d′″ indicate the number of the respective siloxane unit in the compound and is each independently an integer in the range of 0 to 100 000, with the proviso that the sum of a, b, b′, c, c′, c″, d, d′, d″, d′″ together has at least the value 2 and at least one of the indices b′, c′, c″, d′, d″ or d′″ is not equal to 0; and
(c) at least one cationic compound of general formula (III)
([M(II)Cp]⁺)ₐX^{a-} (III),
where M is selected from the group consisting of silicon, and germanium, and Cp is a π-bonded cyclopentadienyl radical of general formula (IIIa) 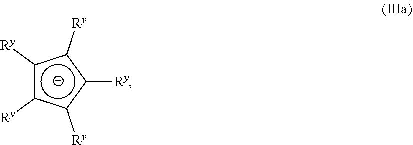
where the radicals R^{y} are each independently selected from the group consisting of (i) triorganosilyl radical of formula —SiR^{b}₃, where the radicals R b are each independently C₁-C₂₀-hydrocarbon radical, (ii) hydrogen, (iii) unsubstituted or substituted C₁-C₂₀-hydrocarbon radical, and (iv) unsubstituted or substituted C₁-C₂₀-hydrocarbonoxy radical, wherein two radicals R^{y} may also in each case form with each other a monocyclic or polycyclic C₂-C₂₀-hydrocarbon radical, and where substituted means in each case that in the hydrocarbon or hydrocarbonoxy radical at least one carbon atom may also be replaced by one Si atom,
X^{a-} is an a valent anion and
a can take the values 1, 2 or 3;
are brought into contact and reacted.

12. The process as claimed in claim 11, wherein in formula (I) the radicals R¹, R² and R³ are each independently selected from the group consisting of (i) hydrogen, (ii) chlorine, (iii) unsubstituted or substituted C₁-C₁₂-hydrocarbon radical, and (iv) unsubstituted or substituted C₁-C₁₂-hydrocarbonoxy radical; and wherein in formula (I′) the radicals R^{x} are each independently selected from the group consisting of (i) chlorine, (ii) C₁-C₆-alkyl radical, (iii) phenyl, and (iv) C₁-C₆-alkoxy radical, and the indices a, b, b′, c, c′, c″, d, d′, d″, d′″ are each independently selected from an integer in the range of 0 to 1000.

13. The process as claimed in claim 12, wherein in formula (I) the radicals R¹, R² and R³ are each independently selected from the group consisting of (i) hydrogen, (ii) chlorine, (iii) C₁-C₆-alkyl radical, (iv) phenyl, and (v) C₁-C₆-alkoxy radical; and where in formula (I′) the radicals R^{x} are each independently selected from the group consisting of chlorine, methyl, methoxy, ethyl, ethoxy, n-propyl, n-propoxy and phenyl, and the indices a, b, b′, c, c′, c″, d, d′, d″, d′″ are each independently selected from an integer in the range of 0 to 1000.

14. The process as claimed in claim 13, wherein in formula (I) the radicals R′, le and R³ and in formula (I′) the radicals R^{x} are each independently selected from the group consisting of hydrogen, chlorine, methyl, methoxy, ethyl, ethoxy, n-propyl, n-propoxy and phenyl, and wherein the indices a, b, b′, c, c′, c″, d, d′, d″, d′″ are each independently selected from an integer in the range of 0 to 1000.

15. The process as claimed in claim 11, wherein in formula (II) the radicals R^{y} are selected from the group consisting of (i) hydrogen, (ii) unsubstituted or substituted C₁-C₈-hydrocarbon radical, (iii) unsubstituted or substituted C₁-C₈-hydrocarbonoxy radical, and wherein the radicals R^{z} are selected from the group consisting of (i) hydrogen and (ii) unsubstituted C₁-C₈-hydrocarbon radical; and where in formula (II′) the radicals R^{a} are selected from the group consisting of substituted C₁-C₈-hydrocarbon radicals, and where the radicals R^{x} are selected from (i) unsubstituted C₁-C₈-hydrocarbon radical and (ii) unsubstituted C₁-C₈-hydrocarbonoxy radical.

16. The process as claimed in claim 15, wherein in formula (II) the radicals R^{y} are selected from the group consisting of (i) hydrogen, (ii) C₁-C₈-alkyl radical and (iii) C₁-C₈-alkoxy radical, and where the radicals R^{z} are selected from the group consisting of (i) hydrogen, (ii) C₁-C₈-alkyl radical and (iii) phenyl radical; and where in formula (II′) the radicals R^{a} are selected from the group consisting of substituted C₁-C₈-hydrocarbon radicals, and where the radicals R^{x} are selected from unsubstituted C₁-C₈-hydrocarbon radicals.

17. The process as claimed in claim 11, wherein in formula (IIIa) the radicals R^{y} are each independently selected from the group consisting of (i) C₁-C₃-alkyl radical, (ii) hydrogen and (iii) triorganosilyl radical of formula —SiR^{b}₃, where the radicals R b are each independently C₁-C₂₀-alkyl radicals.

18. The process as claimed in claim 11, wherein in formula (III) the anions X⁻ are selected from the group consisting of the compounds of the formulae [B(R^{a})₄]⁻ and [Al(R^{a})₄]⁻, where the radicals R^{a} are each independently selected from aromatic C₆-C₁₄-hydrocarbon radicals, in which at least one hydrogen atom has been each independently substituted by a radical selected from the group consisting of (i) fluorine, (ii) perfluorinated C₁-C₆-alkyl radical, and (iii) triorganosilyl radical of the formula —SiR^{b}₃, where the radicals R b are each independently C₁-C₂₀-alkyl radicals.

19. The process as claimed in claim 18, wherein in formula (III) the anions X⁻ are selected from the group consisting of the compounds of formula [B(R^{a})₄]⁻, where the radicals R^{a} are each independently selected from aromatic C₆-C₁₄-hydrocarbon radicals, in which all hydrogen atoms have been each independently substituted by a radical selected from the group consisting of (i) fluorine and (ii) triorganosilyl radical of formula —SiR^{b}₃, where the radicals R b are each independently C₁-C₂₀-alkyl radicals.

20. The process as claimed in claim 11, wherein the cationic compound of formula (III) is selected from the group consisting of Cp*M+B(C₆F₅)₄⁻;
Cp*M⁺B[C₆F₄(4-TBS)]₄⁻, where TBS=SiMe₂tert-butyl;
Cp*M⁺B(2-NaphF)₄⁻, where 2-NaphF=perfluorinated 2-naphthyl radical; and
Cp*M⁺B[(C₆F₅)₃(2-NaphF)]⁻, where 2-NaphF=perfluorinated 2-naphthyl radical, where M is selected from the group consisting of silicon and germanium, where Cp* is pentamethylcyclopentadienyl.
